(19) United States
(12) Patent Application Publication
(10) Pub. No.: US 2013/0142177 A1
(43) Pub. Date: Jun. 6, 2013

(54) METHOD AND APPARATUS FOR ADJACENT-CHANNEL EMISSION LIMIT DEPENDING ON SYNCHRONIZATION OF INTERFERED RECEIVER

(71) Applicant: Markus Nentwig, Helsinki (FI)

(72) Inventor: Markus Nentwig, Helsinki (FI)

(73) Assignee: NOKIA CORPORATION, Espoo (FI)

(21) Appl. No.: 13/701,393

(22) PCT Filed: Jun. 2, 2010
(86) PCT No.: PCT/IB2010/001329

§ 371 Date: Feb. 7, 2013

(51) Int. Cl. H04W 56/00

(52) U.S. Cl. CPC H04W 56/001
USPC 370/336

(57) ABSTRACT

In accordance with an example embodiment of the present invention, an apparatus comprises a transceiver configured to receive a transmission from a radio node, the transmission including a synchronization signal; a processor configured to determine a state of synchronization with the radio node and based at least in part on the state of synchronization adjusting at least one transmission parameter.

### TECHNICAL FIELD

The present application relates generally to a method and apparatus for adjacent-channel emission limit depending on synchronization of interfered receiver.

### BACKGROUND

In future radio systems it is expected to provide optimized local area (OLA) coverage to a fully loaded cellular system such as a Long Term Evolution (LTE) system. In such radio systems, due to the small cells and the resulting high number of access points, conventional network planning is not suitable. Instead, the radio system is expected to be self-organizing or optimizing. In some self-organizing radio systems, radio nodes autonomously negotiate use of radio resources by broadcasting a reservation signal to inform nearby radio nodes of its reservation.

### SUMMARY

Various aspects of examples of the invention are set out in the claims.

According to a first aspect of the present invention, an apparatus comprises a transceiver configured to receive a transmission from a radio node, the transmission including a synchronization signal; a processor configured to determine a state of synchronization with the radio node and based at least in part on the state of synchronization adjusting at least one transmission parameter.

According to a second aspect of the present invention, a method comprises receiving a transmission from a radio node, the transmission including a synchronization signal; determining a state of synchronization with the radio node; and based at least in part on the state of synchronization adjusting at least one transmission parameter.

According to a third aspect of the present invention, an apparatus comprises at least one processor; and at least one memory including computer program code. The at least one memory and the computer program code are configured to, with the at least one processor, cause the apparatus to perform at least the following: receiving a transmission from a radio node, the transmission including a synchronization signal; determining a state of synchronization with the radio node; and based at least in part on the state of synchronization adjusting at least one transmission parameter.

According to a fourth aspect of the present invention, an apparatus comprises means for receiving a transmission from a radio node, the transmission including a synchronization signal. Means for determining a state of synchronization with the radio node; and based at least in part on the state of synchronization, means for adjusting at least one transmission parameter.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a reservation of a radio resource by a radio node in a wireless system in accordance with an example embodiment of the invention;

FIG. 2 illustrates an example orthogonal frequency division multiplex (OFDM) symbols and a time domain waveform of a subcarrier in the OFDM symbol on a time axis in accordance with an example embodiment of the invention;

FIG. 3 illustrates an example spectrum of an OFDM signal received with a synchronized radio node in accordance with an example embodiment of the invention;

FIG. 4 illustrates an example spectrum of an OFDM signal received with an unsynchronized radio node in accordance with an example embodiment of the invention;

FIG. 5 illustrates an example method for channel emission limit based on synchronization of an interfered receiver in accordance with an example embodiment of the invention;

FIG. 6 illustrates an example method for determining a synchronization error using open loop signaling in accordance with an example embodiment of the invention;

FIG. 7 illustrates example OFDM symbol streams in accordance with an example embodiment of the invention;

FIG. 8 illustrates an example method for determining a synchronization error using closed loop signaling in accordance with an example embodiment of the invention;

FIG. 9 illustrates an example method for determining a state of synchronization for a radio node in accordance with an example embodiment of the invention;

FIG. 10 illustrates an example method for determining if the transmission parameters for a radio node must be adjusted to reduce emissions into a radio resource in accordance with an example embodiment of the invention;

FIG. 11 illustrates an example method for modifying transmission parameters for a radio node in accordance with an example embodiment of the invention;

FIG. 12 illustrates an example method for determining an emission limit in accordance with an example embodiment of the invention; and

FIG. 13 illustrates an example wireless apparatus in accordance with an example embodiment of the invention.

### DETAILED DESCRIPTION OF THE DRAWINGS

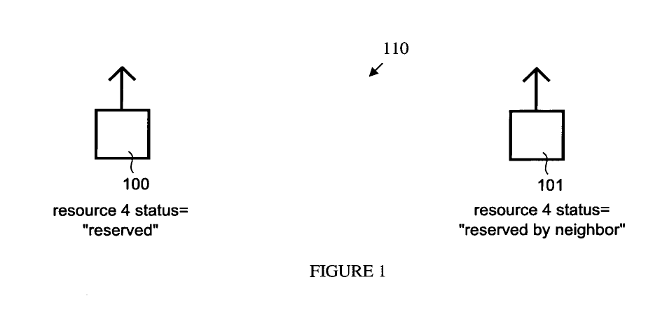

An example embodiment of the present invention and its potential advantages are understood by referring to FIGS. 1 through 13 of the drawings.

FIG. 1 illustrates an example of a reservation of a radio resource by a radio node in a wireless system 110 in accordance with an example embodiment of the invention. The wireless system 110 includes two neighboring radio nodes 100 and 101, accessing a shared medium divided into radio resources. For example, a radio resource may be a frequency subband and/or a channel. Other types of radio resources are for example time slots in a periodic frame structure, a set of orthogonal codewords or a combination thereof. The radio node may also be referred to, without a loss of generality, as a node.

Radio node 100 may use one radio resource identified as r=4. Simultaneous use of the same resource, r=4, by other radio nodes such as radio node 101, for example by transmitting, may cause intolerable interference to radio node 100. Therefore, radio node 100 may acquire a reservation on a radio resource. A reservation limits transmit activity by neighboring radio nodes on the radio resource and thus prevents causing intolerable interference to radio node 100. Hence, FIG. 1 illustrates radio node 100, holding a reservation on radio resource r=4. Further, it shows radio node 101 that is aware of a neighboring radio node reserving resource r=4.

In an example embodiment, a reservation may be assigned by a network operator or a managing entity such as a support radio node.

In another embodiment, reservations are acquired dynamically based at least in part on the availability of radio resources and depending on traffic volume. For example, radio node 100 may sense for beacon signals from other radio nodes transmitted on resource r=4. Detecting none, radio node 100 may consider resource r=4 as free, and reserve it for its own use. Having reserved the resource, radio node 100 may transmit a beacon signal comprising a reservation signal on the radio resource, indicating the reservation to neighboring radio nodes.

Emissions from a radio transmitter are allowed within an assigned frequency band within the bandwidth and tolerance for the frequency band. Emissions which do not meet technical parameters are unwanted emissions comprising spurious emissions and out-of band emissions. Reservations control the maximum amount of emitted power generated by a radio node on a radio resource. For example, radio node 101 in FIG. 1 may be allowed to emit a power of up to 21 dBm on resource r=5, while it holds a reservation on resource r=5 granting it the right to transmit. Radio node 101 may be required to limit its emissions to no more than −19 dBm on resource r=4, because neighboring radio node 100 holds a reservation, and a transmission at a higher level by radio node 101 would cause intolerable interference to reception at radio node 100.

The emission limit to radio node 101 on the radio resource may be chosen to allow radio node 101 to transmit at a very low power on resource r=4 that causes no intolerable interference to the reserving radio node 100. The emission limit may also allow unwanted emissions from radio node 101 into the radio resource. Unwanted emissions may result for example by noise or through distortions caused by various components of the radio system such as amplifier distortion, when transmitting on another resource, such as r=5. Another source of unwanted emissions from a transmitter is sinc leakage. For example, in orthogonal frequency division multiplex (OFDM) or single-carrier frequency division multiple access (SC-FDMA), sinc leakage results from the discontinuity between adjacent symbols. In the wireless system 110 of FIG. 1, radio nodes 100 and 101 may use an OFDM radio scheme to communicate and share radio resources.

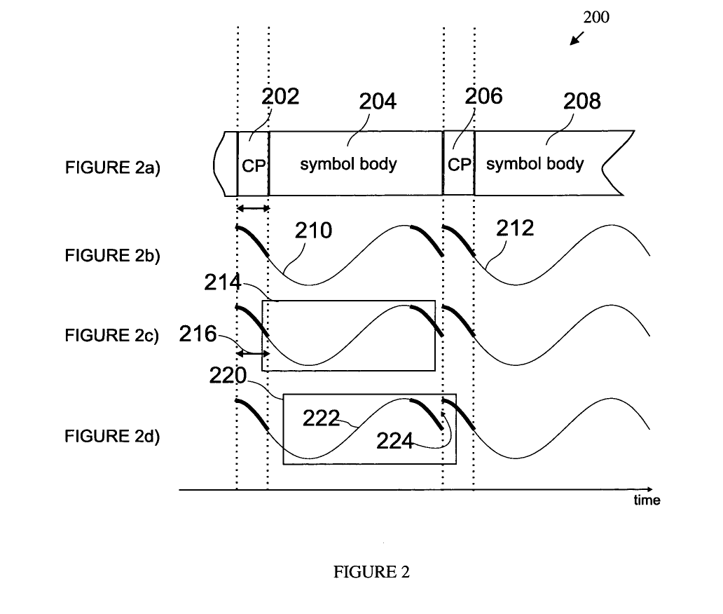

FIG. 2 illustrates example OFDM symbols and a time domain waveform of a subcarrier 200 in the OFDM symbols on a time axis as transmitted by radio nodes 100 and 101 of FIG. 1 in accordance with an example embodiment of the invention.

FIG. 2a shows the symbol structure of an OFDM transmission. Each symbol body 204, 208 is preceded by a cyclic prefix (CP) 202, 206 respectively. CP 202 replicates at least a portion of the end of the symbol body 204 and CP 206 replicates at least a portion of the end of the symbol body 208.

FIG. 2b shows time domain waveforms 210, 212 of a subcarrier in the OFDM symbols.

FIG. 2c shows a time aperture 214 of a receiver radio node that is synchronized with the transmission within the duration of a cyclic prefix (CP) 216. The waveform of the subcarrier is continuous within time aperture 214.

FIG. 2d shows a time aperture 220 of a receiver, that is not synchronized with the transmission. The waveform of the subcarrier 222 exhibits a discontinuity 224 within the time aperture 220. The discontinuity results in the leakage of energy from the subcarrier to subcarriers on other frequencies and appears as unwanted emissions.

A receiver that is synchronized with the transmission is able to periodically expand each received OFDM symbol which is implicitly done in the Fast Fourier Transform (FFT) processing. As a result, for a receiver that is synchronized with the transmission, the sinc-spectrum from any nearby out-of-band subcarrier disappears. This does not hold for an unsynchronized receiver. For an unsynchronized receiver the discontinuity between any two OFDM symbols falls into the FFT window and causes subcarrier leakage into adjacent frequency bands.

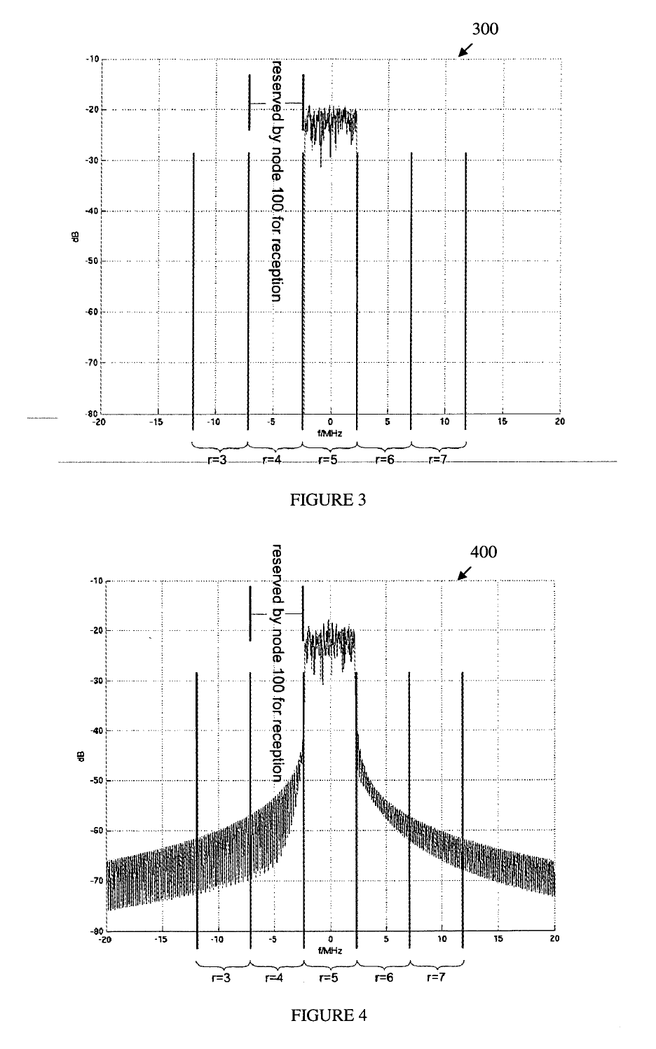

FIG. 3 illustrates an example spectrum of an OFDM signal 300, as illustrated in FIG. 2c, received with a synchronized radio node in accordance with an example embodiment of the invention The transmitter, for example radio node 101 of FIG. 1, uses a radio resource corresponding to a 5 MHz subband marked as “r=5”. For an ideal transmitter, no other emissions are created into adjacent and nearby subbands r=3, r=4, r=6 and r=7.

FIG. 4 illustrates an example spectrum of an OFDM signal 400, as illustrated in FIG. 2d, received with an unsynchronized radio node in accordance with an example embodiment of the invention. The transmitter, for example radio node 101 of FIG. 1, uses a radio resource corresponding to a 5 MHz subband marked as “r=5”. Unsynchronized reception causes sinc leakage that results in energy leaking from the transmission in subband r=5 into adjacent subbands r=4, r=6 and to a lesser extent into nearby subbands r=3, r=7 and other frequency regions. For example, the amount of sinc leakage into subbands r=4, r=6 may be 30 dB below the transmit power in subband r=5 (−30 dBc). The sinc leakage into subbands r=3, r=7 may be −35 dBc.

As can be seen from FIGS. 3 and 4, the amount of interference caused by radio node 101 transmitting in resource r=5 may cause interference to reception at radio node 100 in resource r=4. The interference may depend on the state of synchronization between transmitter radio node 101 and receiver radio node 100.

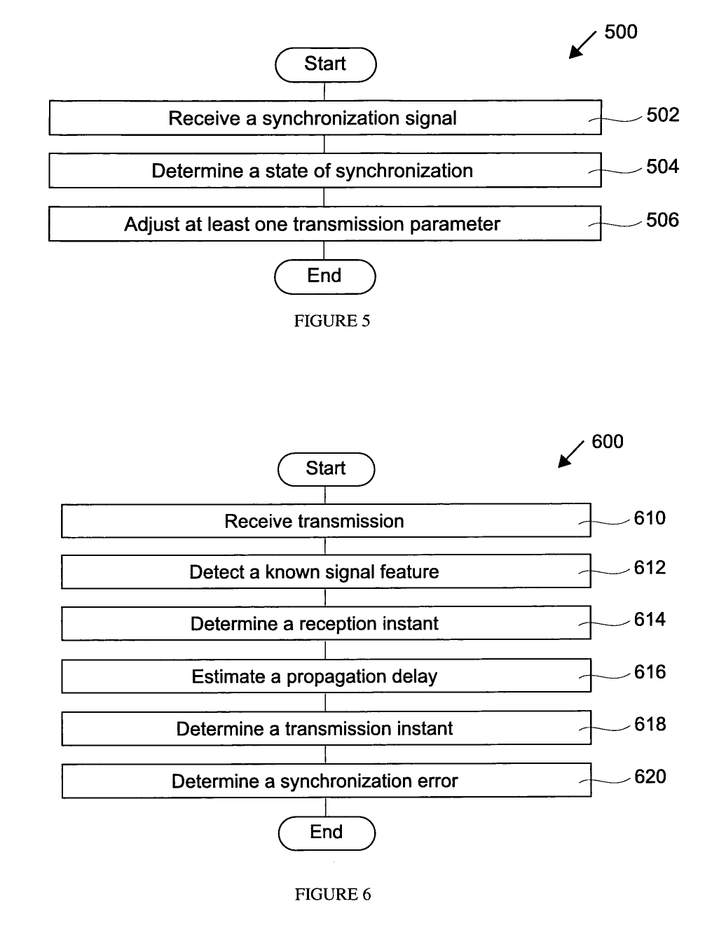

FIG. 5 illustrates an example method 500 for channel emission limit based on synchronization of an interfered receiver in accordance with an example embodiment of the invention. Method 500 may be executed by radio node 101 of wireless system 110 of FIG. 1. The radio node executing the process may be aware of a reservation of radio resource r=4 by another radio node, such as radio node 100 of wireless system 110 of FIG. 1.

The method 500 comprises receiving a transmission, for example from a radio node 100 of wireless system 110, at block 502. In an example embodiment, the transmission comprises a synchronization signal. In accordance with an example embodiment of the invention, the synchronization signal is at least one of a reservation signal, pilot signal, preamble, synchronization sequence, a known signal feature, and/or the like. In accordance with an example embodiment of the invention, the received synchronization signal at block 502 may be either an open loop synchronization message or a closed loop synchronization message.

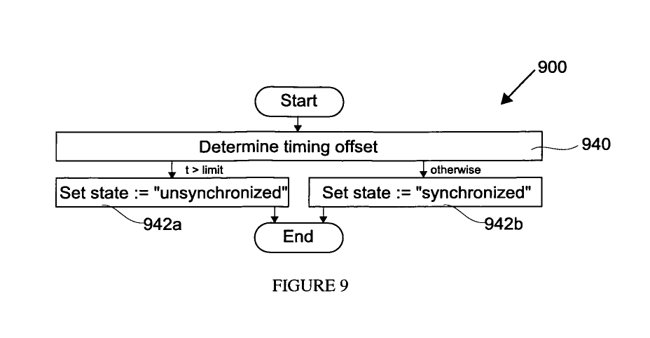

The method 500 further comprises determining a state of synchronization, by radio node 101 of wireless system 110 of FIG. 1 with the radio node 100 of wireless system 110 of FIG. 1, at block 504. An example implementation of block 504 is described in detail by example method 900 of FIG. 9.

The method 500 further comprises adjusting at least one transmission parameter, by radio node 101 of wireless system 110 of FIG. 1, at block 506.

In accordance with an example embodiment of the invention, adjusting at least one transmission parameter comprises adjusting at least one transmission parameter such as transmit power, an average magnitude of a set of subcarriers, a number of unused subcarriers at a band edge, and a number of subcarriers near a band edge with arbitrary content chosen to reduce sinc leakage.

FIG. 6 illustrates an example method 600 for determining a synchronization error using open loop signaling in accordance with an example embodiment of the invention. The synchronization error determined by method 600 is used at least in part to determine a radio node state of synchronization with radio node 101 of wireless system 110 of FIG. 1 as described in block 504 of method 500 of FIG. 5. Method 600 may be executed by radio node 101 of wireless system 110 of FIG. 1.

The method 600 comprises receiving a transmission, for example from a radio node, such as radio node 100 of wireless system 110, at block 610. In an example embodiment, receiving a transmission from a radio node includes receiving a beacon broadcast. A beacon broadcast may advertise the presence of a radio node to other radio nodes. For example, a beacon broadcast may advertise the cell ID, a network ID or other information for establishing a communication link with the broadcasting radio node. In accordance with an example embodiment of the invention, the transmission comprises a reservation signal. A reservation signal may announce a reservation of the transmitting radio node on a radio resource. In accordance with an example embodiment of the invention, a reservation signal and a beacon broadcast are encoded into the same transmission.

In accordance with an example embodiment of the invention, the transmission comprises a synchronization signal. A synchronization signal may be encoded into the same transmission as a beacon broadcast or a reservation signal. A synchronization signal may enable the receiver to accurately determine a reception instant of the transmission. A synchronization signal may comprise signal features known at a receiver. Known signal features comprise for example pilots such as pilot tones or pilot symbols, preambles, synchronization sequences, power envelopes or predefined waveforms such as Constant Amplitude Zero Autocorrelation (CAZAC) sequences.

The method 600 further comprises detecting a known signal feature at block 612. A detection of a known signal feature may be performed for example using a matched filter detector that is configured to the known signal feature.

In an example embodiment, detecting a known signal feature at block 612 may include detecting the known signal feature as the synchronization signal.

The method 600 further comprises determining a reception instant at block 614. Determining a reception instant may be implemented for example using a sliding-window correlator or a matched filter.

In an example embodiment, determining a reception instant at block 614 may include detecting a reception instant of the known signal feature. The known signal feature may comprise a predetermined waveform that is transmitted at regular intervals as a synchronization pulse. The detector may utilize a matched filter configured to the predetermined waveform and a peak detector. The reception instant may be determined based on the detection time instant of a peak using the peak detector in combination with a known processing delay of the matched filter. The peak detector may compare the output of the matched filter against a threshold. The peak detector may further determine the reception instant by determining a time within a time window where the output of the matched filter reaches a maximum.

The method 600 further comprises estimating a propagation delay at block 616. In an example embodiment, estimating a propagation delay at block 616 may include estimating the difference between detected reception instant and estimated transmission instant. In an example embodiment, a received signal strength of the transmission is determined. Based at least on a known transmit strength, a path loss of the radio channel between the radio nodes is estimated. A propagation delay of the radio path is estimated by indexing a lookup table using the estimated path loss.

In another example embodiment, the propagation delay at block 616 is estimated as a predetermined constant, and the constant may be 0.

At block 618 a transmission instant is determined. In an example embodiment, estimating a transmission instant at block 618 comprises estimating a timing, such as for example frame or symbol-level timing of the radio node transmitting the transmission.

In another example embodiment, determining a transmission instant at block 618 may include estimating the transmit time instant by subtracting the propagation delay from the detected reception time instant.

At block 620, a synchronization error is determined. In an example embodiment, determining the synchronization error at block 620 may include calculating the synchronization error as the difference between the determined transmission instant at a radio node 100 of wireless system 110 of FIG. 1 and the nearest OFDM symbol border at a radio node 101 of wireless system 110 of FIG. 1.

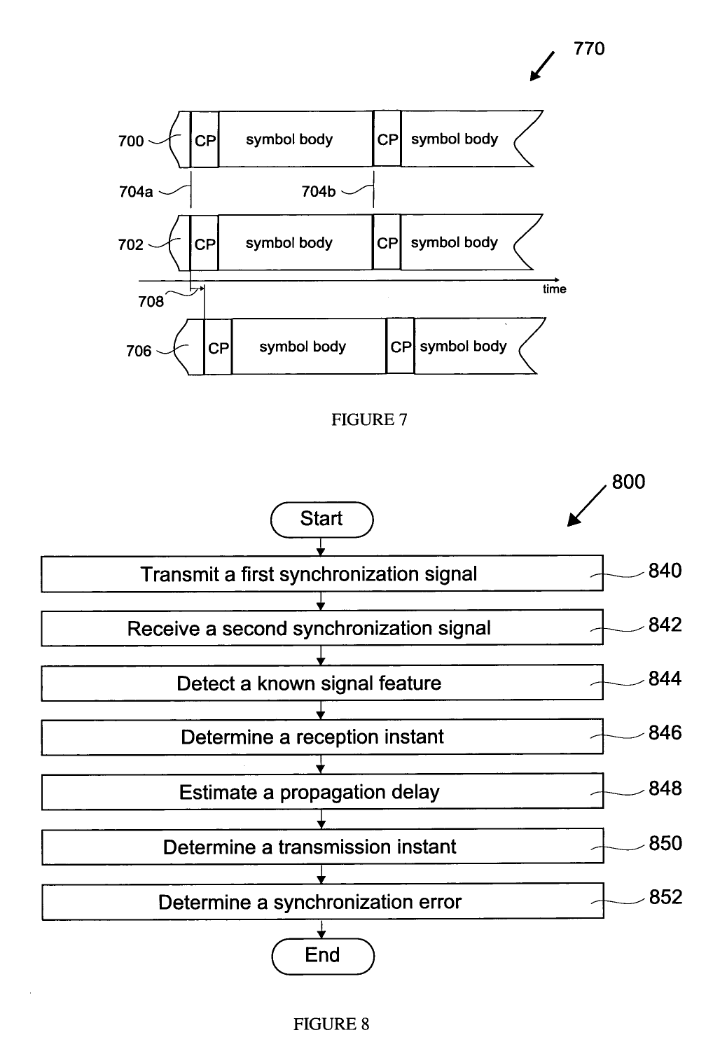

FIG. 7 illustrates example OFDM symbol streams 770 with a first OFDM symbol stream 700 at radio node 100 and a second symbol stream 702 at radio node 101 of wireless system 110 of FIG. 1 in accordance with an example embodiment of the invention.

In FIG. 7, 704a and 704b indicate symbol boundaries denoting transmission time instants of a first symbol and cyclic prefix and transmission time instants of a subsequent symbol and cyclic prefix. In this example, the symbol level timing of the two OFDM symbol streams 700, 702 is aligned with each other. This corresponds to no synchronization error between radio nodes 100 and 101 of wireless system 110 of FIG. 1. Third OFDM symbol stream 706 illustrates a signal stream transmitted by radio node 100 and received by radio node 101 (or vice versa) of wireless system 110 of FIG. 1. The received stream is delayed by the propagation delay 708 of the radio channel.

FIG. 8 illustrates an example method 800 for determining a synchronization error using closed loop signaling in accordance with an example embodiment of the invention. The synchronization error determined by method 800 is used at least in part to determine a radio node state of synchronization with radio node 101 of wireless system 110 of FIG. 1 as described, for example, in block 504 of method 500 of FIG. 5. Method 800 may be executed by radio node 101 of wireless system 110 of FIG. 1.

The method 800 comprises transmitting a first synchronization signal, for example from a radio node, such as radio node 101 of wireless system 110, at block 840. In an example embodiment, transmitting a first synchronization signal at block 840 may include a forward message in a closed-loop synchronization scheme. A closed-loop synchronization scheme uses bidirectional messaging between radio nodes.

At block 842, a second synchronization signal is received in response. Thus, the first synchronization signal may solicit the recipient radio node to transmit a second synchronization signal which is received at block 842. The first and second synchronization signals may provide information for a closed-loop synchronization scheme.

The method 800 further comprises detecting a known signal feature at block 844. In an example embodiment, detecting a known signal feature includes detecting a known signal feature of the second synchronization signal. A detection of a known signal feature may be performed for example using a matched filter detector that is configured to the known signal feature.

The method 800 further comprises determining a reception instant at block 846. In an example embodiment, determining a reception instant at block 846 includes determining a reception instant of the second synchronization signal.

The method 800 further comprises estimating a propagation delay d at block 848. In an example embodiment, estimating a propagation delay d of the radio path is based on the reception instant of the second synchronization signal. The estimation of the propagation delay may include utilizing information encoded into the second synchronization signal and/or the transmit time instant of the first synchronization signal.

The method 800 further comprises determining a transmission instant at block 850. In an example embodiment, the transmission instant, at block 850, may be determined by subtracting the propagation delay estimate from the determined reception time instant.

The method 800 further comprises determining a synchronization error e at block 852. In an example embodiment, estimating the synchronization error e, at block 852, may include calculating the synchronization error e as the difference between the determined transmission instant at radio node 100 and the nearest OFDM symbol border at radio node 101 of wireless system 110 of FIG. 1 as described in FIG. 7.

FIG. 9 illustrates an example method 900 for determining a state of synchronization for a radio node in accordance with an example embodiment of the invention. The example method 900 is an example implementation of block 504 of method 500 of FIG. 5. Method 900 may be executed by radio node 101 of wireless system 110 of FIG. 1.

The method 900 comprises determining a timing offset t at block 940, based on the timing offset t defining a radio node as unsynchronized at block 942a or synchronized at block 942b. The timing offset t determined by radio node 101 may indicate the reception time of a transmission from radio node 101 arriving at radio node 100, relative to the OFDM symbol timing of radio node 100. For example, the frame timing of radio node 100 may be 0.5 μs early, relative to radio node 101. Further, the propagation delay between radio nodes 100 and 101 may be 0.1 μs. Thus, a message transmitted by radio node 101 may appear 0.6 μs late, when received by radio node 100. Thus, the timing offset in the example may be t=0.6 μs. The timing offset t may be determined based on the synchronization error e and the propagation delay estimate d.

In an example embodiment, timing offset t is determined as t=abs (d+e+c), where “abs” indicate the absolute value, e is the synchronization error, d is the propagation delay estimate and c is a constant. The constant c may comprise for example an implementation-dependent shortening of the effective cyclic prefix length, such as caused by time dispersion from transmitter and receiver filters. Constant c may be predetermined as c=0.05 μs. For example, a positive value for synchronization error e=0.5 μs may indicate that the timing of radio node 100 is 0.5 μs early, relative to radio node 101. The propagation delay estimate d may equal 0.1 μs. The resulting timing offset t may equal 0.65 μs, indicating that a message by radio node 101 may be received 0.65 μs early or late relative to the OFDM symbol timing, when received by radio node 100. The timing offset t is compared against a threshold limit. For example, limit may be 0.5 μs.

If the timing offset exceeds the threshold limit, the state of synchronization is set as “unsynchronized” at block 942a. If the timing offset is less than or equal to the threshold limit, the state of synchronization is instead set as “synchronized” at block 942b.

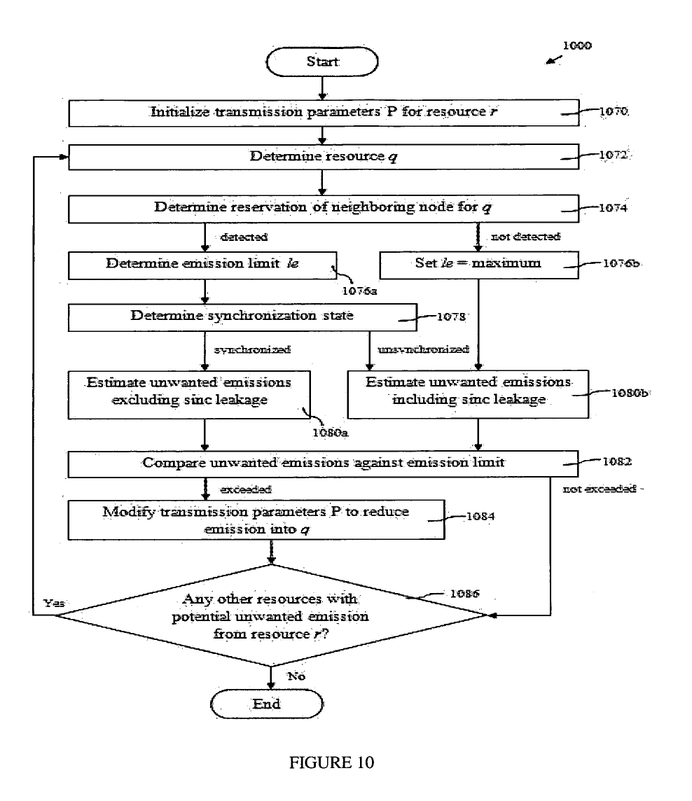

FIG. 10 illustrates an example method 1000 for determining if the transmission parameters for a radio node must be adjusted to reduce emissions into a radio resource in accordance with an example embodiment of the invention. Method 1000 may implement block 506 of method 500 in FIG. 5. Method 1000 may be executed by radio node 101 of wireless system 110 of FIG. 1.

The method 1000 comprises initializing a set of transmission parameters P for transmission on a resource r at block 1070. The initial transmission parameters may result in high data throughput, but also a high level of unwanted emissions into resources, e.g., subbands adjacent to resource r.

At block 1072, a resource q where unwanted emissions are to be limited is determined. For example, it may be known that the transmitter may cause a significant level of unwanted emissions into three resources both below and above r. In this case, the resource q may be selected from the six resources.

At block 1074, for resource q, the state of reservation of a neighboring radio node is determined. In an example embodiment, reservations are assigned manually by an operator. In such a case, the state of reservation may be looked up from a memory. In another embodiment, radio nodes reserve resources dynamically during operation, and signal the reservation information to neighboring radio nodes using a transmission. A reservation may be signaled for example by a reservation message. A reservation may be signaled implicitly by any kind of transmission, as detailed for example at block 610 of method 600 of FIG. 6 or block 840, 842 of method 800 of FIG. 8, when it is agreed beforehand that a radio node may not transmit at all without a reservation.

If at block 1074, it is determined that the state of reservation is detected, process continues to block 1076a. Otherwise, if at block 1074, it is determined that the state of reservation is not detected the process continues to block 1076b.

At block 1076a an emission limit le that would prevent intolerable interference with the neighboring radio node that reserves resource q is determined. In an example embodiment, the emission limit le is determined based at least in part on a message received from the neighboring radio node reserving resource q of block 1074. In another embodiment, the emission limit le is set to a predetermined constant. The emission limit le may be set, for example, to −19 dBm to comply with the requirements of a radio standard.

If no reservation of a neighboring radio node for resource q has been detected at block 1074, the emission limit le is set to a maximum value at block 1076b. In an example embodiment, the maximum value may be a predetermined constant. The maximum value may be equal, for example, to 21 dBm to comply with the requirements of a radio standard.

From block 1076b, where the emission limit le is set to a maximum, the process continues to block 1080b where the level of unwanted emissions including sinc leakage is estimated.

From block 1076a, the process continues to block 1078 where a state of synchronization with the neighboring radio node reserving resource q is determined. In an example embodiment, determining a state of synchronization may include utilizing a message received from the neighboring radio node reserving resource q of block 1074. Determining a state of synchronization may comprise detection of a transmission from the radio node reserving resource q.

If at block 1078 a state of synchronization with the neighboring radio node reserving resource q is determined as synchronized, process continues to block 1080a. The level of unwanted emissions not including sinc leakage is estimated at block 1080a.

If at block 1078 a state of synchronization with the neighboring radio node reserving resource q is determined as unsynchronized, process continues to block 1080b. For the radio node reserving resource q determined as unsynchronized the level of unwanted emissions including sinc leakage is estimated at block 1080b.

Both block 1080a and 1080b continue to block 1082. At block 1082, the estimated level of unwanted emissions is compared against the emission limit le. If the estimated level of unwanted emissions exceed the emission limit le, the process continues at block 1084. If at block 1082 the estimated level of unwanted emissions do not exceed the emission limit le the process continues at block 1086.

At block 1084 at least one transmission parameter P is modified to reduce emissions into resource q so that the emission limit le is not exceeded. Estimating a level of unwanted emissions, at block 1080b for an unsynchronized radio node, including sinc leakage may result in a higher estimate than estimating a level of unwanted emissions, at block 1080a for a synchronized radio node, excluding sinc leakage. As a consequence, modifying transmission parameters at block 1084 for a synchronized radio node may result in increasing a level of unwanted emissions into a neighboring radio channel, compared to an unsynchronized radio node. For a synchronized radio node, transmissions from another synchronized radio node appear confined to the frequency range of utilized subcarriers and the transmission does not cause interference. This does not hold for transmissions from an unsynchronized radio node which causes interference due to sinc-leakage.

At block 1086, it is checked if there are other resources with potential unwanted emissions from resource r. If such resources are identified, method 1000 continues to block 1072. If there are no additional resources, with potential unwanted emissions from resource r, method 1000 ends.

In an example embodiment, block 1074 may determine reservations of resource q by several neighboring radio nodes. In this case, block 1076a determines a per-radio node emission limit le for each neighboring radio node reserving resource q. A per-radio node state of synchronization is determined at block 1078 for each neighboring radio node. At blocks 1080a or 1080b, a per-radio node unwanted emissions are estimated for each neighboring radio node, based on the per-radio node state of synchronization of the individual radio node. At block 1082, the estimated level of unwanted emissions per-radio node is compared against the per-radio node emission limit le. If the estimated level of unwanted emissions per-radio node do not exceed the emission limit le the process continues at block 1086. If the estimated level of unwanted emissions per-radio node exceed the emission limit le the process continues at block 1084. At block 1084, transmission parameters are than modified until no per-radio node emission limit is exceeded by the per-radio node unwanted emissions to the same radio node. The process continues at block 1086.

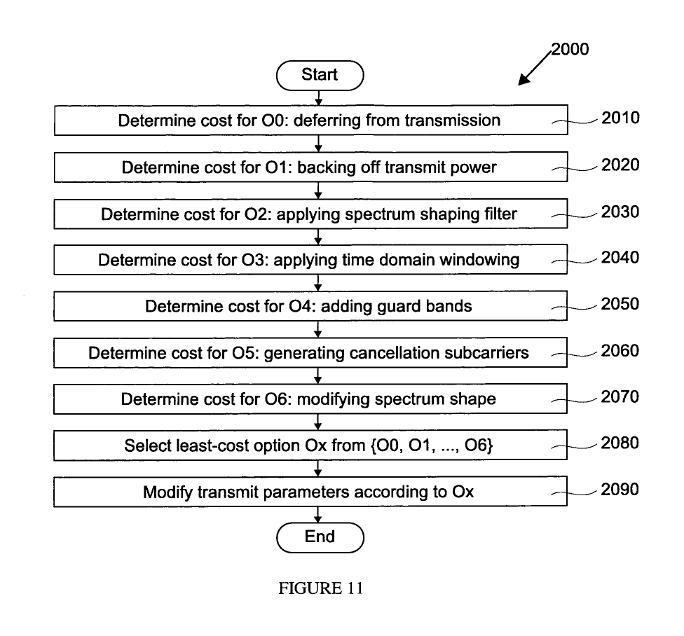

FIG. 11 illustrates an example method 2000 for modifying transmission parameters P to reduce unwanted emissions into a resource in accordance with an example embodiment of the invention. Method 2000 is an example implementation of block 1084 of method 1000 of FIG. 10. Method 2000 may be executed by radio node 101 of wireless system 110 of FIG. 1. Method 2000 may choose from a set of options. The options may indicate an action that, applied to a signal transmitted on resource r, will suppress unwanted emissions into resource q below emission limit le. The example method 2000 may determine a cost associated with an option. A high cost may correspond to a large reduction of data transmission capability, high expended transmit power or high computational complexity to implement the option, for example.

At block 2010, a cost c0 is determined for the option O0 of deferring from transmission on resource r. In an example embodiment, deferring from transmission on resource r may be a viable option, when a state of unsynchronization has been detected with a radio node on a resource q that is adjacent to r or separated by a guard band.

At block 2020, a cost c1 is determined for the option O1 of backing off transmit power.

At block 2030, a cost c2 is determined for the option O2 of applying spectrum shaping filtering. Spectrum shaping filtering may be applied for example by enabling a digital filter on a transmit baseband signal.

At block 2040, a cost c3 is determined for the option O3 of applying time domain windowing on a transmitted OFDM symbol.

At block 2050, a cost c4 is determined for the option O4 of adding guard bands to a transmitted OFDM symbol. Guard bands may be added for example by reducing the number of subcarriers used for data transmission.

At block 2060, a cost c5 is determined for the option O5 of inserting cancellation subcarriers into a transmitted OFDM symbol. Cancellation subcarriers may be inserted for example by reducing the number of subcarriers used for data transmission, and assigning a value to subcarriers not used for data transmission that minimizes sinc leakage of the transmitted signal.

At block 2070, a cost c6 is determined for the option O6 of modifying the spectrum shape of a transmitted OFDM symbol. The spectrum shape of a transmitted OFDM symbol can be modified for example by assigning different power levels to subcarriers used for data transmission, depending on the location of the subcarrier in frequency.

At block 2080, the option Ox associated with the lowest cost is selected. In an example embodiment, options O1-O6 are modified to suppress unwanted emissions into resource q, but not necessarily below emission limit le. Further, block 2080 is to select a plurality of modified options that in combination suppress unwanted emissions into resource q below emission limit le. In an alternative embodiment, block 2080 may select a combination of guard bands and spectrum shaping filtering that reduces emissions into resource q below emission limit le.

Method 2000 concludes at block 2090 where transmit parameters P are modified by implementing the selected option Ox.

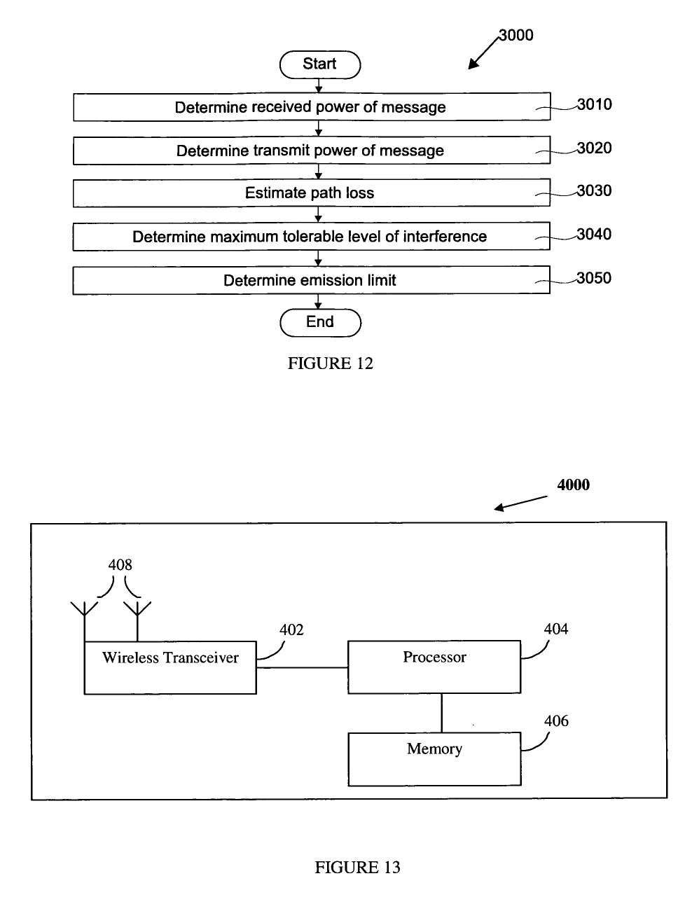

FIG. 12 illustrates an example method 3000 for determining an emission limit in accordance with an example embodiment of the invention. Method 3000 is an example implementation of block 1076a of method 1000 in FIG. 10. Method 3000 may be executed by radio node 101 of wireless system 110 of FIG. 1.

Method 3000 comprises determining the received power of a message received from radio node 100, at block 3010. The message may have been received at block 1074 of method 1000 of FIG. 10.

At block 3020, the transmitted power of the message is determined. In an example embodiment, the transmitted power is encoded into the message by radio node 100, and determined by decoding it from the message. In another embodiment, the transmitted power is a predetermined constant.

At block 3030, the path loss encountered by the message is estimated. The path loss may be estimated by subtracting the received power from the transmitted power.

At block 3040, a maximum tolerable level of interference at radio node 100 is determined. In an example embodiment, a maximum tolerable level of interference is encoded into the message, and determined by decoding the message. In another embodiment, the maximum tolerable level of interference is a predetermined constant. In yet another embodiment, the maximum tolerable level of interference is determined by estimating an average noise level at radio node 101 in unreserved radio resources.

At block 3050, emission limit le is determined by adding the path loss estimate to the maximum tolerable level of interference.

FIG. 13 illustrates a simplified block diagram 4000 of an example wireless apparatus such as one of the radio nodes 100 and 101 described in FIG. 1, that is suitable for use in practicing the example embodiments of this invention. Apparatus 4000 may include a processor 404, a memory 406 coupled to the processor 404, and a suitable wireless transceiver 402 coupled to the processor 404, coupled to an antenna unit 408.

The wireless transceiver 402 is for bidirectional wireless communications with another wireless device and includes a beacon detector. The wireless transceiver 402 may be configured with multiple transceivers including multiple antennas 408. The wireless transceiver 402 may provide frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast fourier transforming (IFFT)/fast fourier transforming (FFT), cyclic prefix appending/removal, and other signal processing functions. For the purposes of clarity, the description here separates the description of this signal processing from the RF and/or radio stage and conceptually allocates that signal processing to some analog baseband processing unit and/or the processor 404 or other central processing unit. In some embodiments, the wireless transceiver 402, portions of the antenna unit 408, and an analog baseband processing unit may be combined in one or more processing units and/or application specific integrated circuits (ASICs).

The antenna unit 408 may be provided to convert between wireless signals and electrical signals, enabling the wireless apparatus 4000 to send and receive information from a cellular network or flexible spectrum use (FSU) network or some other available wireless communications network or from a peer wireless device. In an embodiment, the antenna unit 408 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna unit 408 may include antenna tuning and/or impedance matching components, RF power amplifiers, and/or low noise amplifiers.

The processor 404 of the wireless apparatus may be of any type suitable to the local application environment, and may include one or more of general-purpose computers, special-purpose computers, microprocessors, digital signal processors (“DSPs”), field-programmable gate arrays (FPGAs), application-specific integrated circuits (ASICs), and processors based on a multi-core processor architecture, as non-limiting examples.

The processor 404 or some other form of generic central processing unit (CPU) or special-purpose processor such as digital signal processor (DSP), may operate to control the various components of the wireless apparatus 4000 in accordance with embedded software or firmware stored in memory 406 or stored in memory contained within the processor 404 itself. The processor 404 includes capability to recover timing for determining synchronization between radio nodes. In addition to the embedded software or firmware, the processor 404 may execute other applications or application modules stored in the memory 406 or made available via wireless network communications. The application software may comprise a compiled set of machine-readable instructions that configures the processor 404 to provide the desired functionality, or the application software may be high-level software instructions to be processed by an interpreter or compiler to indirectly configure the processor 404.

The memory 406 of the wireless apparatus, as introduced above, may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 406 may include program instructions or computer program code that, when executed by an associated processor, enable the communication element to perform tasks as described herein.

The processor 404 is configured to determine a state of synchronization for a receiving radio node with a transmitting radio node and compare an estimated level of unwanted emissions against a determined emission limit. The processor 404, using the memory 406, based at least in part on the state of synchronization adjusts transmission parameters for the wireless transceiver 402.

Without in any way limiting the scope, interpretation, or application of the claims appearing below, a technical effect of one or more of the example embodiments disclosed herein is to determine and classify a radio node as synchronized or unsynchronized based on a reservation signal received from a neighboring radio node. Another technical effect of one or more of the example embodiments disclosed herein is to disregard sinc leakage into the neighbor's reserved band when shaping the transmit signal if a radio node is determined synchronized and effectively use higher emission limit and utilize subcarriers up to the band edge. Another technical effect of one or more of the example embodiments disclosed herein is to take sinc leakage into the neighbor's reserved band into account, when shaping the transmit signal if the radio node is determined unsynchronized and use a lower emission limit, leave guard band and/or lower power at the band edge.

Embodiments of the present invention may be implemented in software, hardware, application logic or a combination of software, hardware and application logic. The software, application logic and/or hardware may reside on user equipment (UE), mobile station, base station, access point or radio node. If desired, part of the software, application logic and/or hardware may reside on user equipment, part of the software, application logic and/or hardware may reside on access point, and part of the software, application logic and/or hardware may reside on radio node. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with an example of a computer described and depicted in FIG. 13. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-25. (canceled)

26. An apparatus, comprising:
a transceiver configured to receive a transmission from a radio node, the transmission including a synchronization signal; and
a processor configured to:
determine a state of synchronization with the radio node; and
based at least in part on the state of synchronization adjust at least one transmission parameter to control a leakage to the radio node.

27. The apparatus according to claim 26, wherein the synchronization signal is at least one of a reservation signal, a pilot signal, a preamble, a synchronization sequence, a power envelope and a predefined waveform.

28. The apparatus according to claim 26, wherein the synchronization signal comprises a message used in a closed-loop synchronization scheme.

29. The apparatus according to claim 26 wherein the apparatus is further configured to determine the state of synchronization with the radio node based on:
a reception instant for the synchronization signal;
an offset relative to a frame timing;
a comparison of the offset to a threshold; and
a determination of a radio node state as synchronized if the offset is less than or equal to the threshold.

30. The apparatus according to claim 26 wherein a synchronized radio node is not configured to adjust the transmission parameters to account for sinc leakage.

31. The apparatus according claim 26 wherein a synchronized radio node is configured to adjust the transmission parameters to result in increase of a level of unwanted emissions.

32. The apparatus according to claim 26 wherein an unsynchronized radio node is configured to adjust the transmission parameters to account for sinc leakage.

33. The apparatus according to claim 26 wherein an unsynchronized radio node is configured to adjust the transmission parameters to result in reduce of a level of unwanted emissions.

34. The apparatus according to claim 26 wherein the apparatus is further configured to adjust at least one of a transmit power, a guard band width, cancellation subcarriers, a windowing and a spectral shape of the transmission signal.

35. The apparatus according to claim 34, wherein the apparatus is further configured to adjust the transmission parameters to defer from transmission on a first radio resource when a state of unsynchronization has been detected with a radio node using a second radio resource.

36. The apparatus according to claim 35, wherein the apparatus is further configured to adjust the transmission parameters to defer from transmission on a first radio resource when a state of unsynchronization has been detected with a radio node using a second radio resource, and wherein the second radio resource occupies a frequency band adjacent to or separated by a guard band from a frequency band of the first resource.

37. The apparatus according to claim 26 wherein at least one of the synchronization signal and reservation signal is an orthogonal frequency division multiplex signal or a single-carrier frequency division multiple access signal.

38. A method, comprising:
receiving a transmission from a radio node, the transmission including a synchronization signal;
determining a state of synchronization with the radio node; and
based at least in part on the state of synchronization adjusting at least one transmission parameter to control a leakage to the radio node.

39. The method of claim 38, wherein the synchronization signal is at least one of a reservation signal, a pilot signal, a preamble, a synchronization sequence, a power envelope and a predefined waveform.

40. The method according to claim 38, wherein determining the state of synchronization with the radio node comprises:
determining a reception instant for the synchronization signal;
determining an offset relative to a frame timing;
comparing the offset to a threshold; and
determining a radio node state as synchronized if the offset is less than or equal to the threshold.

41. The method according to claim 38 wherein for a synchronized radio node adjusting the transmission parameters does not include accounting for sinc leakage.

42. The method according to claim 38 wherein for a synchronized radio node adjusting the transmission parameters results in increasing a level of unwanted emissions.

43. The method according to claim 38 wherein for an unsynchronized radio node adjusting the transmission parameters includes accounting for sinc leakage.

44. The method according to claim 38 wherein for an unsynchronized radio node adjusting the transmission parameters results in reducing a level of unwanted emissions.

45. A computer program product comprising a program code stored in a non-transitory computer readable medium, the program code configured at least to cause:
receiving a transmission from a radio node, the transmission including a synchronization signal;
determining a state of synchronization with the radio node; and
based at least in part on the state of synchronization, adjusting at least one transmission parameter to control a leakage to the radio node.
